(19) United States
(12) Patent Application Publication
(10) Pub. No.: US 2024/0186843 A1
(43) Pub. Date: Jun. 6, 2024

(54) MOTOR

(71) Applicant: DENSO CORPORATION, Kariya-city (JP)

(72) Inventors: Naoto NATSUME, Kariya-city (JP); Masayuki Echizen, Kariya-city (JP)

(73) Assignee: DENSO CORPORATION, Kariya-city (JP)

(21) Appl. No.: 18/403,177

(22) Filed: Jan. 3, 2024

Related U.S. Application Data
(63) Continuation of application No. PCT/JP2022/017401, filed on Apr. 8, 2022.

(30) Foreign Application Priority Data
Jul. 8, 2021 (JP) 2021-113742

(51) Int. Cl. H02K 1/14; H02K 1/278; H02K 21/16

(52) U.S. Cl. CPC H02K 1/146; H02K 1/278; H02K 21/16

(57) ABSTRACT

A motor includes a rotor and a stator. The rotor includes a magnet and is rotatably supported. The stator includes a stator core that includes a plurality of tooth main body portions made of a magnetic material and disposed with space therebetween in a circumferential direction, and a plurality of tooth tip portions disposed opposing the magnet and each formed in an end portion on the rotor side of the plurality of tooth main body portions, and a plurality of coils formed around the plurality of tooth main body portions by a conductive winding being wound. In the motor, the tooth tip portions are configured to include a plurality of first tooth tip portions that have the same shape and size as one another, and one or more second tooth tip portions that are different from the first tooth tip portions in at least either of the shape and size.

### CROSS-REFERENCE TO RELATED APPLICATION

The present application is a continuation application of International Application No. PCT/JP2022/017401, filed on Apr. 8, 2022, which claims priority to Japanese Patent Application No. 2021-113742, filed on Jul. 8, 2021. The contents of these applications are incorporated herein by reference in their entirety.

### BACKGROUND

### Technical Field

The present disclosure relates to a motor.

### Related Art

A motor in which a rotor is disposed on an inner side in a radial direction of a stator is known. The stator configures a portion of the motor and includes a plurality of winding magnetic poles around which windings are wound and a plurality of non-winding magnetic poles around which windings are not wound. The plurality of non-winding magnetic poles are disposed between pairs of winding magnetic poles that are adjacent to each other in a circumferential direction and are also disposed at fixed intervals in the circumferential direction.

### SUMMARY

One aspect of the present disclosure provides a motor that includes: a rotor that includes a magnet and is rotatably supported; and a stator that includes a stator core that includes a plurality of tooth main body portions that are made of a magnetic material and disposed with space therebetween in a circumferential direction, and a plurality of tooth tip portions that are disposed opposing the magnet and each formed in an end portion on the rotor side of the plurality of tooth main body portions, and a plurality of coils that are each formed around the plurality of tooth main body portions by a conductive winding being wound. In the motor, the plurality of tooth tip portions are configured to include a plurality of first tooth tip portions that have the same shape and size as one another, and one or more second tooth tip portions that are different from the plurality of first tooth tip portions in at least either of the shape and size.

### BRIEF DESCRIPTION OF THE DRAWINGS

In the accompanying drawings:

FIG. 1 is a plan view schematically illustrating a motor according to a first embodiment;

FIG. 2 is an enlarged perspective view in which a portion of a stator of the motor according to the first embodiment is enlarged;

FIG. 3 is a perspective view of the motor according to the first embodiment;

FIG. 4 is a graph illustrating a relationship between a number of teeth having a second tooth tip portion and cogging torque;

FIG. 5 is a graph illustrating a relationship between a size in a circumferential direction of the second tooth tip portion and the cogging torque;

FIG. 6 is a plan view schematically illustrating a motor according to a second embodiment;

FIG. 7 is a plan view schematically illustrating a motor according to a third embodiment; and

FIG. 8 is a plan view schematically illustrating a motor according to a fourth embodiment.

### DESCRIPTION OF THE EMBODIMENTS

JP 2016-019389 A discloses a motor in which a rotor is disposed on an inner side in a radial direction of a stator. The stator that configures a portion of the motor described in JP 2016-019389 A includes a plurality of winding magnetic poles around which windings are wound and a plurality of non-winding magnetic poles around which windings are not wound. In addition, the plurality of non-winding magnetic poles are disposed between pairs of winding magnetic poles that are adjacent to each other in a circumferential direction and are also disposed at fixed intervals in the circumferential direction. As a result, vibration and resonance attributed to a large circumferential-direction pitch between peaks in excitation force can be suppressed without worsening cogging torque, induced voltage distortion, and winding factor, and without increasing adverse effects of multipolarization.

In the configuration described in JP 2016-019389 A, space in which the winding wound around the winding magnetic pole is disposed is thought to become narrow as a result of the non-winding magnetic pole being present. Consequently, torque increase in the motor is thought to be hindered. In addition, in the configuration described in JP 2016-019389 A, there is room for improvement from the perspective of obtaining desired cogging torque characteristics.

It is thus desired to provide a motor that has desired cogging torque characteristics while suppressing hindrance to torque increase.

An exemplary embodiment of the present disclosure provides a motor that includes: a rotor that includes a magnet and is rotatably supported; and a stator that includes a stator core that includes a plurality of tooth main body portions that are made of a magnetic material and disposed with space therebetween in a circumferential direction, and a plurality of tooth tip portions that are disposed opposing the magnet and each formed in an end portion on the rotor side of the plurality of tooth main body portions, and a plurality of coils that are each formed around the plurality of tooth main body portions by a conductive winding being wound. In the motor, the plurality of tooth tip portions are configured to include a plurality of first tooth tip portions that have the same shape and size as one another, and one or more second tooth tip portions that are different from the plurality of first tooth tip portions in at least either of the shape and size.

The plurality of coils may be each formed around the plurality of tooth main body portions by the conductive winding being wound by concentrated winding. The one or more second tooth tip portions may be a plurality of second tooth tip portions. The plurality of tooth main body portions in which the plurality of second tooth tip portions are formed in the end portions on the rotor side may be disposed at intervals at a same angle as a mechanical angle corresponding to an integer multiple of an electrical angle of 360° along the circumferential direction. A size in the circumferential direction of the second tooth tip portion may be set to be smaller than a size in the circumferential direction of the first tooth tip portion, and cogging torque of the motor may have increased compared to a case in which the size in the circumferential direction of the second tooth tip portion is set to be the same as the size in the circumferential direction of the first tooth tip portion.

As a result of a configuration such as this, a motor that has desired cogging torque characteristics can be provided while suppressing hindrance to torque increase.

The above-described exemplary embodiment of the present disclosure will be further clarified through the detailed description below, with reference to the accompanying drawings.

### (Motor 10 According to a First Embodiment)

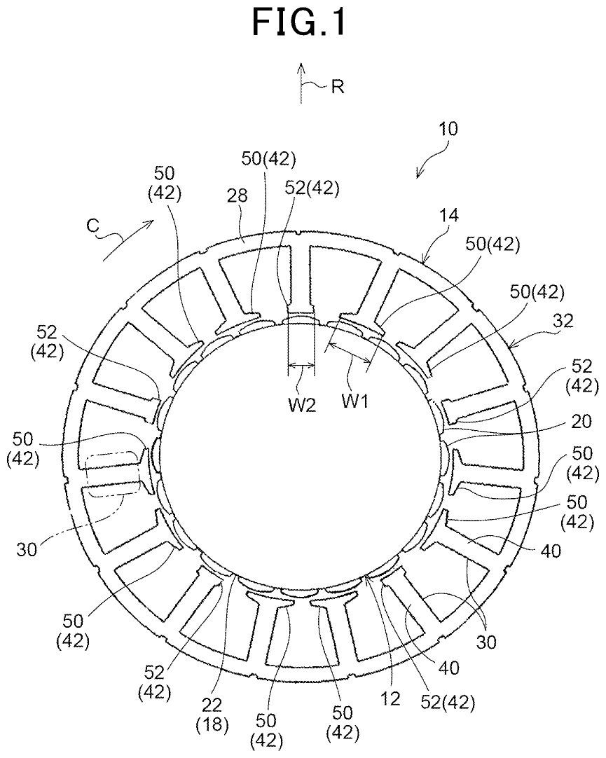

A motor 10 according to a first embodiment of the present disclosure will be described with reference to FIG. 1 to FIG. 3. Here, an arrow Z direction, an arrow R direction, and an arrow C direction shown accordingly in the drawings respectively indicate a first side in a rotation axial direction, an outer side in a rotation radial direction, and a first side in a rotation circumferential direction of a rotor 12, described hereafter. In addition, when merely an axial direction, a radial direction, and a circumferential direction are indicated hereafter, these indicate a rotation axial direction, a rotation radial direction, and a rotation circumferential direction of the rotor 12 unless particularly stated otherwise.

As shown in FIG. 1 to FIG. 3, the motor 10 according to the present embodiment is a motor that has three phases, twenty poles, and fifteen slots, and is used as an actuator of a vehicle. The motor 10 is configured to include a stator 14, a rotor 12 that rotates by the stator 14 generating magnetism (magnetic field), and a sensor 16 (magnetic sensor) for detecting a rotation angle of the rotor 12.

The rotor 12 has twenty poles and is disposed on the inner side in the radial direction of the stator 14, described hereafter. The rotor 12 includes an annular rotor core 18 that is fixed to a rotation shaft (not shown) and a plurality (twenty) of magnets 20 that are fixed to an outer circumferential portion of the rotor core 18.

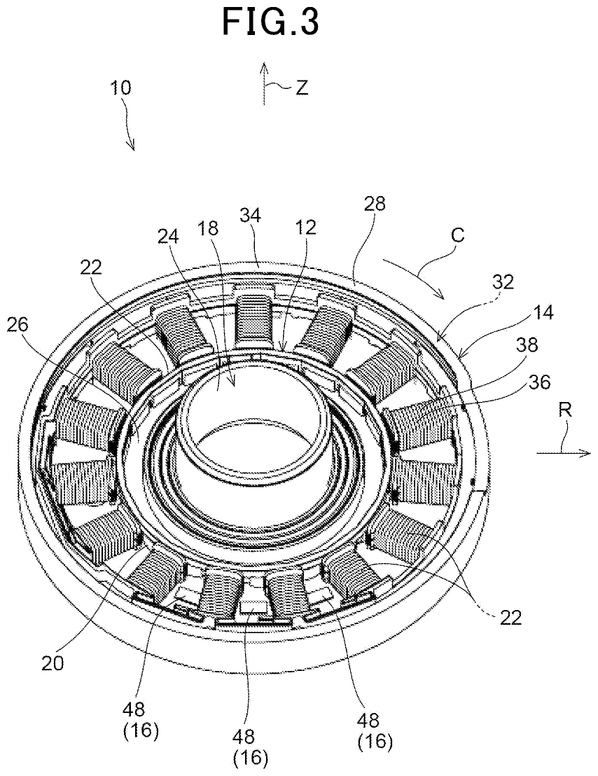

As shown in FIG. 3, the rotor core 18 includes a large diameter portion 22 that is formed into a cylindrical shape, and a small diameter portion 24 that is disposed on the inner side in the radial direction of the large diameter portion 22 and of which an inner diameter and an outer diameter are respectively set to be less than an inner diameter and an outer diameter of the large diameter portion 22. In addition, the rotor core 18 includes a connecting portion 26 that connects the large diameter portion 22 and the small diameter portion 21 in the radial direction.

The plurality of magnets 20 are formed into a rectangular shape when viewed from the outer side in the radial direction. In addition, a surface on the outer side in the radial direction of the plurality of magnets 20 protrudes toward the outer side in the radial direction when viewed from the axial direction and is curved into a circular cylindrical surface shape. Furthermore, the plurality of magnets 20 are disposed with a fixed amount of space therebetween in the circumferential direction. That is, the plurality of magnets 20 are disposed at regular intervals in the circumferential direction. In addition, the plurality of magnets 20 are fixed to the surface on the outer side in the radial direction of the large diameter portion 22 of the rotor core 18. Here, according to the present embodiment, the magnet 20 of which the outer side in the radial direction is an N pole and the magnet 20 of which the outer side in the radial direction is an S pole are alternately disposed along the circumferential direction.

The stator 14 includes a back core 28 that formed into an annular shape and a stator core 32 that has a plurality (fifteen) of teeth 30 protruding from a surface on the inner side in the radial direction of the back core 28 toward the inner side in the radial direction. Here, the stator core 23 according to the present embodiment is a laminated core formed by steel plates that are a magnetic material being laminated in the axial direction. In addition, the stator 14 includes an insulator 34 that is attached to the stator core 32 and coils 38 that are formed by conductive windings 36 being wound around the plurality of teeth 30 of the stator core 32.

The plurality of teeth 30 of the stator core 32 are formed to be substantially T-shaped when viewed from the axial direction and are disposed at regular intervals in the circumferential direction. In addition, the plurality of teeth 30 according to the present embodiment are formed symmetrically in the circumferential direction when viewed from the axial direction. The teeth 30 include tooth main body portions 40 having a prismatic shape that protrude from an inner circumferential surface of the back core 28 toward the inner side in the radial direction, and tooth tip portions 42 that extend from an end portion on the inner side in the radial direction of the tooth main body portion 40 to the first side and the second side in the circumferential direction. The tooth main body portions 40 of the plurality of teeth 30 are set to have the same shape and size as one another. A surface on the inner side in the radial direction of the tooth tip portion 42 is curved in the circumferential direction at a predetermined curvature radius.

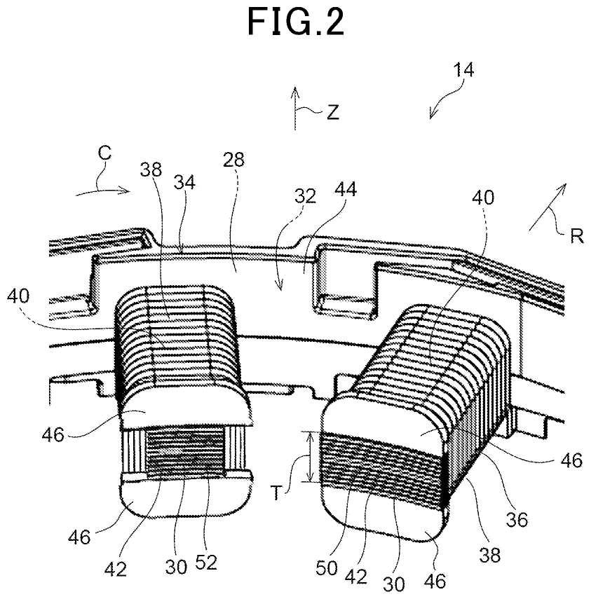

As shown in FIG. 2 and FIG. 3, the insulator 34 that is attached to the stator core 32 is made of an insulating material such as a resin material. As an example, the insulator 34 has a structure that is divided into two in the axial direction. The insulator 34 includes a back-core covering portion 44 that covers both end surfaces in the axial direction of the back core 28 and a tooth main-body covering portion that covers the tooth main body portions 40 of the teeth 30. In addition, the insulator 34 includes a tooth-tip portion covering portion 46 that covers both end surfaces in the axial direction of the tooth tip portion 42. The tooth-tip portion covering portion 46 is formed in a protruding shape in the axial direction relative to the tooth main-body covering portion. In addition, a size in the circumferential direction of the tooth-tip portion covering portion 46 is set to a size that corresponds to a size in the circumferential direction of a first tooth tip portion 50, described hereafter. Here, according to the present embodiment, the plurality of tooth-tip portion covering portions 46 are set to have the same shape and size as one another.

The coil 38 is formed by the conductive winding 36 being wound around the tooth main body portion 40 of each tooth 30 covered by the tooth main-body covering portion of the insulator 34. According to the present embodiment, fifteen coils 38 are formed around the tooth main-body portions 40 of the fifteen teeth 30. Here, in the coil 38 according to the present embodiment, the windings 36 that configure the coil 38 of each phase are connected by a neutral point terminal (not shown). In addition, a terminal of each winding 36 that configure the coil 38 of each phase is connected to a circuit board connection terminal (not shown).

As shown in FIG. 3, the sensor 16 according to the present embodiment is a magnetic sensor. The sensor 16 includes a sensor main body 48 that is formed into a rectangular block shape. A center portion of the sensor main body 48 is a sensing point that detects magnetism of the magnet 20. In addition, the sensor 16 includes a connecting portion (not shown) that protrudes from the sensor main body 48 toward the first side. As a result of the connecting portion being joined to a circuit board by soldering, the sensor 16 is attached to the circuit board. In addition, according to the present embodiment, the sensor main body 48 of the sensor 16 is disposed between a pair of teeth 30 that are adjacent to each other in the circumferential direction. Furthermore, according to the present embodiment, three sensors 16 are disposed to be concentrated in a portion in the circumferential direction of the stator 14.

Next, a configuration of the tooth tip portion 42 that is a configuration of a main section according to the present embodiment will be described.

As shown in FIG. 1, according to the present embodiment, the plurality of tooth tip portions 42 are configured to include a plurality (ten) of first tooth tip portions 50 that are set to have the same shape and size as one another, and a plurality (five) of second tooth tip portions 52 that are different from the first tooth tip portions 50 in the shape and size.

As shown in FIG. 1 and FIG. 2, in the first tooth tip portion 50, the size in the circumferential direction is W1 and the size in the axial direction is set to T. A thickness size in the radial direction of the first tooth tip portion 50 gradually decreases toward the end portion side in the circumferential direction of the first tooth tip portion 50. The first tooth tip portion 50 according to the present embodiment is formed symmetrically in the circumferential direction when viewed from the axial direction.

The second tooth tip portion 52 is configured similarly to the first tooth tip portion 50, excluding a size W2 in the circumferential direction being set to a smaller size than the size W1 in the circumferential direction of the first tooth tip portion 50. According to the present embodiment, the five second tooth tip portions 52 are set to have the same shape and size as one another. In addition, the second tooth tip portion 52 according to the present embodiment is formed symmetrically in the circumferential direction when viewed from the axial direction.

Here, the teeth 30 (tooth main body portions 40) that include the second tooth tip portions 52 are disposed at intervals that are at the same angle as a mechanical angle that corresponds to an integer multiple of an electrical angle of 360° along the circumferential direction.

Here, the motor 10 according to the present embodiment has twenty magnetic poles. Therefore, the mechanical angle corresponding to the electrical angle of 360° is 36°. Here, the interval in the circumferential direction between a pair of teeth 30 that are adjacent to each other in the circumferential direction is 24°. Therefore, according to the present embodiment, the interval in the circumferential direction of the pair of teeth 30 including the second tooth tip portions 52 that are adjacent to each other in the circumferential direction is set to a least common multiple 72° of the mechanical angle of 36° corresponding to the electrical angle of 360° and the interval 24° in the circumferential direction of the pair of teeth 30 that are adjacent to each other in the circumferential direction. As a result, the five teeth 30 (tooth main body portions 40) including the second tooth tip portions 52 are disposed at regular intervals along the circumferential direction. Here, two teeth 30 including the first tooth tip portions 50 are disposed between a pair of teeth 30 including the second tooth tip portions 52 that are adjacent to each other in the circumferential direction.

### (Workings and Effects According to the Present Embodiment)

Next, workings and effects according to the present embodiment will be described.

As shown in FIG. 1 to FIG. 3, in the motor 10 according to the present embodiment, the coil 38 of the stator 14 is energized and a rotating magnetic field is generated around the stator 14. As a result, the rotor 12 rotates.

In addition, when the rotor 12 rotates, the plurality of magnets 20 of the rotor 12 successively pass the inner side in the radial direction of the sensor main body 48 of each sensor 16. Furthermore, changes in magnetic flux density of the plurality of magnets 20 at the position of the sensor main body 48 of each sensor 16 is detected by each sensor 16. As a result, a rotation angle, a rotation speed, and the like of the rotor 12 can be calculated.

In addition, according to the present embodiment, the second tooth tip portion 52 is different from the first tooth tip portion 50 in size and shape. As a result, the cogging torque of the motor 10 can be increased, compared to a case in which all teeth 30 are configured to have the first tooth tip portion 50. Furthermore, the present embodiment makes it unnecessary to provide non-winding magnetic poles, such as auxiliary teeth, between the teeth 30 that are adjacent to each other in the circumferential direction to increase the cogging torque of the motor 10. This can suppress decrease in space factor due to the non-winding magnetic poles, such as auxiliary teeth, being provided, and can suppress hindrance to torque increase in the motor. That is, according to the present embodiment, the motor 10 having the desired cogging toque characteristics can be provided while hindrance to torque increase is suppressed.

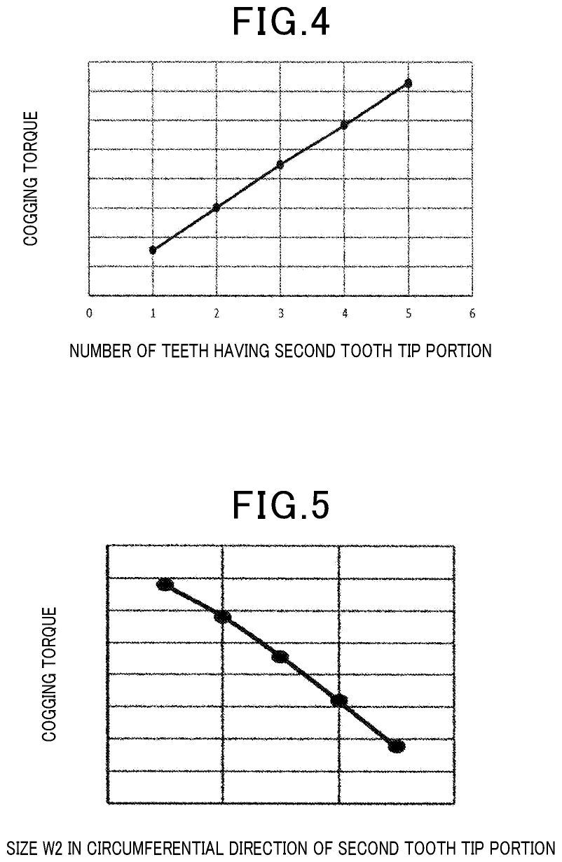

Here, FIG. 4 shows a graph in which the number of teeth 30 having the second tooth tip portion 52 is a horizontal axis and a value of the cogging toque is a vertical axis. As shown in FIG. 4, as the number of teeth 30 having the second tooth tip portion 52 increases from one to five, the cogging torque can be increased. Here, the number of teeth 30 having the second tooth tip portion 52 may be set as appropriate taking into consideration a required value of the cogging torque and the like.

In addition, FIG. 5 shows a graph in which the size W2 in the circumferential direction of the second tooth tip portion 52 is the horizontal axis and the value of the cogging torque is the vertical axis. As shown in FIG. 5, as the size W2 in the circumferential direction of the second tooth end portion 52 decreases, the cogging torque can be increased. Here, the size W2 in the circumferential direction of the second tooth tip portion 52 may be set as appropriate taking into consideration the required value of the cogging torque and the like.

Furthermore, as shown in FIG. 1, according to the present embodiment, the plurality of second tooth tip portions 52 are set to have the same shape and size as one another. Moreover, the teeth 30 (tooth main body portions 40) having the second tooth tip portions 52 are disposed at regular intervals along the circumferential direction. As a result, generation of irregular vibration and noise during rotation of the rotor 12 can be suppressed while the cogging torque has increased as described above.

In addition, as shown in FIG. 2, according to the present embodiment, the size in the circumferential direction of the tooth-tip portion covering portion 46 of the insulator 34 is set to a size corresponding to the size in the circumferential direction of the first tooth tip portion 50. As a result, the insulator 34 that is attached to the stator core 32 that has the first tooth tip portions 50 and the second tooth tip portions 52, and the insulator 34 that is attached to the stator core 32 that has only the first tooth tip portions 50 can be shared.

### (Motor 54 According to a Second Embodiment)

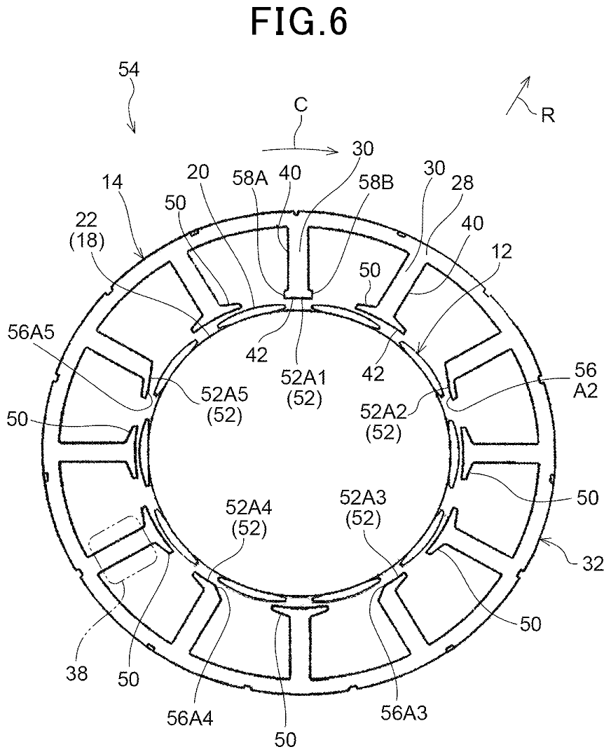

Next, a motor 54 according to a second embodiment will be described with reference to FIG. 6. Here, components and sections of the motor 54 according to the second embodiment corresponding to those of the above-described motor 10 according to the first embodiment are given the same reference numbers as the corresponding components and sections of the motor 10 according to the first embodiment. Descriptions thereof may be omitted.

As shown in FIG. 6, the motor 54 according to the present embodiment is a motor that has three phases, ten magnetic poles, and twelve slots. The motor 54 is configured to include the stator 14 in which the coil 38 is formed around each of the twelve teeth 30, and the rotor 12 that has ten magnets 20 and in which the ten magnets 20 are disposed at regular intervals along the circumferential direction. Here, according to the present embodiment, the magnet 20 of which the outer side in the radial direction is the N pole and the magnet 20 of which the outer side in the radial direction is the S pole are alternately disposed along the circumferential direction. In addition, in the motor 54 according to the present embodiment, the five second tooth tip portions 52 are different from one another in size and shape.

Here, the five second tooth tip portions 52 are referred to as a second tooth tip portion 52A1, a second tooth tip portion 52A2, a second tooth tip portion 52A3, a second tooth tip portion 52A4, and a second tooth tip portion 52A5, in order along the circumferential direction.

The second tooth tip portion 52A1 is configured similarly to the second tooth tip portion 52 of the above-described motor 10 according to the first embodiment.

The second tooth tip portion 52A2 is formed having an asymmetrical shape in the circumferential direction when viewed from the axial direction. The second tooth tip portion 52A2 extends toward the second tooth tip portion 52A3 side adjacent to the second tooth tip portion 52A2 in the circumferential direction. In addition, in an intermediate portion in the circumferential direction of a surface on the inner side in the radial direction of the second tooth tip portion 52A2, a bent portion 56A2 that serves as a changing portion in which a proportion of an amount of change in a position in the radial direction to an amount of change in a position in the circumferential direction changes is formed.

The second tooth tip portion 52A3 is formed into an asymmetrical shape in the circumferential direction when viewed from the axial direction. The second tooth tip portion 52A3 extends toward the second tooth tip portion 52A2 side adjacent to the second tooth tip portion 52A3 in the circumferential direction. In other words, the second tooth tip portion 52A3 extends toward a side opposite the second tooth tip portion 52A4 adjacent to the second tooth tip portion 52A3 in the circumferential direction. In addition, in an intermediate portion in the circumferential direction of a surface on the inner side in the radial direction of the second tooth tip portion 52A3, a bent portion 56A3 that serves as a changing portion in which a proportion of an amount of change in a position in the radial direction to an amount of change in a position in the circumferential direction changes is formed.

The second tooth tip portion 52A4 is formed into an asymmetrical shape in the circumferential direction when viewed from the axial direction. The second tooth tip portion 52A4 extends toward a side opposite the second tooth tip portion 52A3 adjacent to the second tooth tip portion 52A4 in the circumferential direction. In other words, the second tooth tip portion 52A4 extends toward the second tooth tip portion 52A5 side adjacent to the second tooth tip portion 52A4 in the circumferential direction. In addition, in an intermediate portion in the circumferential direction of a surface on the inner side in the radial direction of the second tooth tip portion 52A4, a bent portion 56A4 that serves as a changing portion in which a proportion of an amount of change in a position in the radial direction to an amount of change in a position in the circumferential direction changes is formed. Here, the second tooth tip portion 52A4 and the second tooth tip portion 52A3 have opposite shapes in the circumferential direction when viewed from the axial direction.

The second tooth tip portion 52A5 is formed into an asymmetrical shape in the circumferential direction when viewed from the axial direction. The second tooth tip portion 52A5 extends toward the second tooth tip portion 52A4 adjacent to the second tooth tip portion 52A5 in the circumferential direction. In addition, in an intermediate portion in the circumferential direction of a surface on the inner side in the radial direction of the second tooth tip portion 52A5, a bent portion 56A5 that serves as a changing portion in which a proportion of an amount of change in a position in the radial direction to an amount of change in a position in the circumferential direction changes is formed. Here, the second tooth tip portion 52A5 and the second tooth tip portion 52A2 have opposite shapes in the circumferential direction when viewed from the axial direction.

In addition, an end 58A on the second side in the circumferential direction of the second tooth tip portion 52A1, the bent portion 56A2 of the second tooth tip portion 52A2, and the bent portion 56A4 of the second tooth tip portion 52A4 are disposed at intervals at the same angle as the mechanical angle corresponding to the integer multiple of the electrical angle of 360° along the circumferential direction. Here, the motor 54 according to the present embodiment has ten magnetic poles. Therefore, the mechanical angle corresponding to the electrical angle of 360° is 72°. Specifically, the interval to the first side in the circumferential direction between the end 58A on the second side in the circumferential direction of the second tooth tip portion 52A1 and the bent portion 56A2 of the second tooth tip portion 52A2 is 72°. Furthermore, the interval to the first side in the circumferential direction between the end 58A on the second side in the circumferential direction of the second tooth tip portion 52A1 and the bent portion 56A4 of the second tooth tip portion 52A4 is 216°.

In addition, an end 58B on the first side in the circumferential direction of the second tooth tip portion 52A1, the bent portion 56A5 of the second tooth tip portion 52A5, and the bent portion 56A3 of the second tooth tip portion 52A3 are disposed at intervals at the same angle as the mechanical angle corresponding to the integer multiple of the electrical angle of 360° along the circumferential direction. Specifically, the interval to the second side in the circumferential direction between the end 58B on the first side in the circumferential direction of the second tooth tip portion 52A1 and the bent portion 56A5 of the second tooth tip portion 52A5 is 72°. Furthermore, the interval to the second side in the circumferential direction between the end 58B on the first side in the circumferential direction of the second tooth tip portion 52A1 and the bent portion 56A3 of the second tooth tip portion 52A3 is 216°.

In the motor 54 according to the present embodiment described above, the end 58A on the second side in the circumferential direction of the second tooth tip portion 52A1, the bent portion 56A2 of the second tooth tip portion 52A2, and the bent portion 56A4 of the second tooth tip portion 52A4 are disposed at intervals at the same angle as the mechanical angle corresponding to the integer multiple of the electrical angle of 360° along the circumferential direction. In addition, the end 58B on the first side in the circumferential direction of the second tooth tip portion 52A1, the bent portion 56A5 of the second tooth tip portion 52A5, and the bent portion 56A3 of the second tooth tip portion 52A3 are disposed at intervals at the same angle as the mechanical angle corresponding to the integer multiple of the electrical angle of 360° along the circumferential direction. As a result, compared to a configuration in which the second tooth tip portions 52A2, 52A3, 52A4, and 52A5 are set to have the same shape and size as the second tooth tip portion 52A1, the motor 54 according to the present embodiment can further increase the cogging torque.

In addition, as a result of the configuration in which the second tooth tip portions 52A2, 52A3, 52A4, and 52A5 are formed in asymmetrical shapes in the circumferential direction when viewed from the axial direction and extend to either side in the circumferential direction, the configuration for increasing the cogging torque can be easily provided as described above.

### (Motor 60 According to a Third Embodiment)

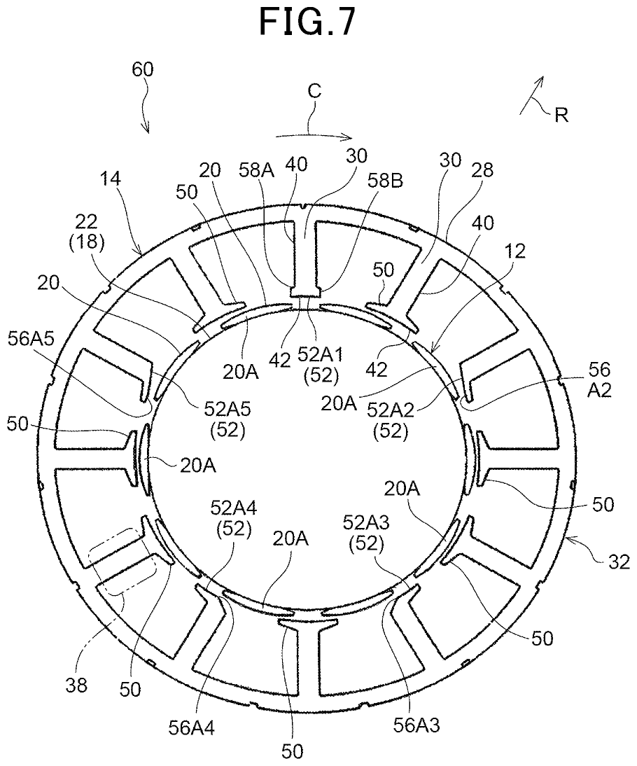

Next, a motor 60 according to a third embodiment will be described with reference to FIG. 7. Here, components and sections of the motor 60 according to the third embodiment corresponding to those of the above-described motors 10 and 54 according to the first and second embodiments are given the same reference numbers as the corresponding components and sections of the motors 10 and 54 according to the first and second embodiments. Descriptions thereof may be omitted.

As shown in FIG. 7, a configuration of the motor 60 according to the present embodiment is similar to the configuration of the motor 54 according to the second embodiment, excluding a difference in the arrangement of the plurality of magnets 20 configuring a portion of the rotor 12.

Here, according to the present embodiment, five magnets 20 are disposed so as to be shifted to the second side in the circumferential direction relative to positions presuming that the ten magnets 10 are disposed at regular intervals along the circumferential direction. According to the present embodiment, five magnets 20 of which the outer side in the radial direction is the N pole or five magnets 20 of which the outer side in the radial direction is the S pole are disposed so as to be shifted to the second side in the circumferential direction relative to the above-described positions. In other words, positions of magnetic pole centers of the five magnets 20 that are disposed at intervals at a mechanical angle of 72° in the circumferential direction, among the ten magnets 20, are disposed so as to be shifted to the second side in the circumferential direction relative to the positions when the ten magnets 20 are disposed at regular intervals in the circumferential direction. Here, the five magnets 20 that are disposed so as to be shifted to the first side in the circumferential direction relative to the above-described positions are referred to as offset magnets 20A.

In the motor 60 according to the present embodiment described above, as a result of the five magnets 20 among the ten magnets 20 being the offset magnets 20A, the cogging toque can be further increased compared to that in the motor 54 according to the second embodiment.

### (Motor 62 According to a Fourth Embodiment)

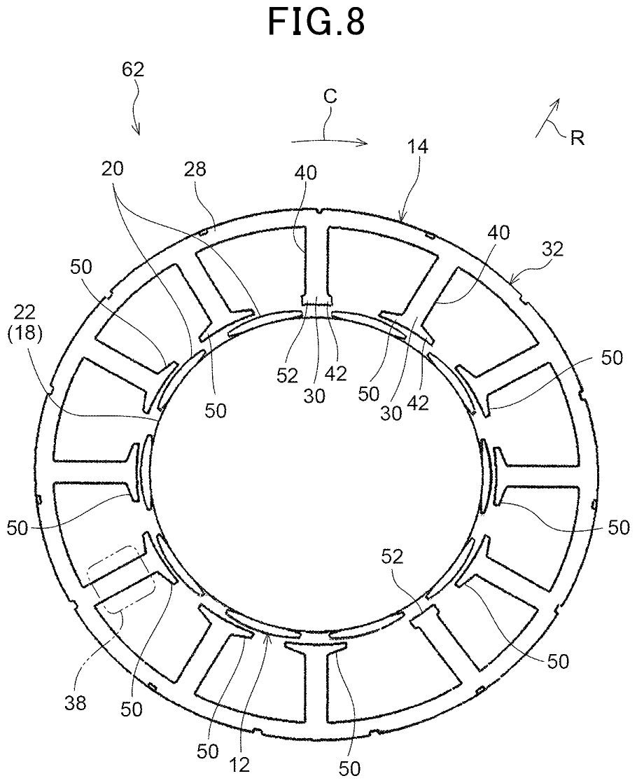

Next, a motor 62 according to a fourth embodiment will be described with reference to FIG. 8. Here, components and sections of the motor 62 according to the fourth embodiment corresponding to those of the above-described motors 10, 54, and 60 according to the first, second, and third embodiments are given the same reference numbers as the corresponding components and sections of the motors 10, 54, and 60 according to the first, second, and third embodiments. Descriptions thereof may be omitted.

As shown in FIG. 8, the motor 62 according to the present embodiment includes two second tooth tip portions 52. Here, the teeth 30 (tooth main body portions 40) that have one second tooth tip portions 52 are disposed in positions that are shifted by 6° toward the second side in the circumferential direction relative to positions presuming the twelve teeth 30 (tooth main body portions 40) are disposed at regular intervals. As a result, the interval to the second side in the circumferential direction between the tooth 30 that has one second tooth tip portion 52 and the tooth 30 that has the other second tooth tip portion 52 is 144°. Here, 144° is an angle that is twice the mechanical angle of 72° corresponding to the electrical angle of 360°.

In the motor 62 according to the present embodiment described above, compared to a configuration in which the teeth 30 (tooth main body portions 40) that have one second tooth tip portions 52 are disposed in positions presuming that the twelve teeth 30 (tooth main body portions 40) are disposed at regular intervals, the cogging torque can be increased.

Here, according to the embodiments described above, examples in which the configuration of the present disclosure is applied to the motor 10 that has twenty poles and fifteen slots, and the motors 54, 60, and 62 that have ten poles and twelve slots are described. However, the present invention is not limited thereto.

For example, the configuration of the present disclosure can also be applied to motors having a two-pole, three-slot system, such as two poles and three slots, four poles and six slots, six poles and nine slots, eight poles and twelve slots, ten poles and fifteen slots, and twelve poles and eighteen slots. In addition, the configuration of the present disclosure can also be applied to motors having a four-pole, three-slot system, such as four poles and three slots, eight poles and six slots, twelve poles and nine slots, and sixteen poles and twelve slots.

Furthermore, the configuration of the present disclosure can also be applied to motors having a ten-pole, twelve-slot system such as twenty poles and twenty-four slots. In addition, the configuration of the present disclosure can also be applied to motors having a fourteen-pole, twelve-slot system, such as fourteen poles and twelve slots, and twenty-eight poles and twenty-four slots. Furthermore, the configuration of the present disclosure can also be applied to motors having an eight-pole, nine-slot system, such as eight poles and nine slots, and sixteen poles and eighteen slots. Moreover, the configuration of the present disclosure can also be applied to motors having a ten-pole, nine-slot system, such as ten poles and nine slots, and twenty poles and eighteen slots.

An embodiment of the present disclosure is described above. However, the present disclosure is not limited to that described above. It goes without saying that various modifications other than those described above are possible without departing from the spirit of the present disclosure.

In addition, while the present disclosure has been described with reference to embodiments thereof, it is to be understood that the disclosure is not limited to the embodiments and constructions. The present disclosure is intended to cover various modification examples and modifications within the range of equivalency. In addition, various combinations and configurations, and further, other combinations and configurations including more, less, or only a single element thereof are also within the spirit and scope of the present disclosure.

What is claimed is:

1. A motor comprising:
a rotor that includes a magnet and is rotatably supported; and
a stator that includes
a stator core that includes
a plurality of tooth main body portions that are made of a magnetic material and disposed with space therebetween in a circumferential direction, and
a plurality of tooth tip portions that are disposed opposing the magnet and each formed in an end portion on the rotor side of the plurality of tooth main body portions, and
a plurality of coils that are each formed around the plurality of tooth main body portions by a conductive winding being wound by concentrated winding, wherein:
the plurality of tooth tip portions are configured to include
a plurality of first tooth tip portions that have the same shape and size as one another, and
one or more second tooth tip portions that are different from the plurality of first tooth tip portions in at least either of shape and size;
the one or more second tooth tip portions comprise a plurality of second tooth tip portions;
the plurality of tooth main body portions in which the plurality of second tooth tip portions are formed in the end portions on the rotor side are disposed at intervals at a same angle as a mechanical angle corresponding to an integer multiple of an electrical angle of 360° along the circumferential direction; and
a size in the circumferential direction of the second tooth tip portion is set to be smaller than a size in the circumferential direction of the first tooth tip portion, and cogging torque of the motor has increased compared to a case in which the size in the circumferential direction of the second tooth tip portion is set to be the same as the size in the circumferential direction of the first tooth tip portion.

2. The motor according to claim 1, wherein:
the plurality of second tooth tip portions are set to have the same size and shape as one another; and
the plurality of tooth main body portions in which the plurality of second tooth tip portions are formed in the end portion on the rotor side are disposed at regular intervals along the circumferential direction.

3. The motor according to claim 2, wherein:
a changing portion in which a proportion of an amount of change in a position in a radial direction relative to an amount of change in a position in the circumferential direction is changed is formed on a surface on the magnet side of at least a portion of the plurality of second tooth tip portions; and
an end in the circumferential direction of one second tooth tip portion or the changing portion and an end in the circumferential direction of another second tooth tip portion or the changing portion are disposed at an interval at a same angle as a mechanical angle corresponding to an integer multiple of an electrical angle of 360° along the circumferential direction.

4. The motor according to claim 3, wherein:
at least a portion of the plurality of second tooth tip portions is formed asymmetrically in the circumferential direction when viewed from an axial direction by extending to either side of a first side and a second side in the circumferential direction from the plurality of tooth main body portions.

5. The motor according to claim 4, wherein:
a pair of second tooth tip portions that are adjacent to each other in the circumferential direction are formed asymmetrically in the circumferential direction when viewed from the axial direction, and one second tooth tip portion extends toward the other second tooth tip portion side and the other second tooth tip portion extends toward one second tooth tip portion side.

6. The motor according to claim 5, wherein:
a pair of second tooth tip portions that are adjacent to each other in the circumferential direction are formed asymmetrically in the circumferential direction when viewed from the axial direction, and one second tooth tip portion extends toward a side opposite the other second tooth tip portion and the other second tooth tip portion extends toward a side opposite one second tooth tip portion.

7. The motor according to claim 1, wherein:
a changing portion in which a proportion of an amount of change in a position in a radial direction relative to an amount of change in a position in the circumferential direction is changed is formed on a surface on the magnet side of at least a portion of the plurality of second tooth tip portions; and
an end in the circumferential direction of one second tooth tip portion or the changing portion and an end in the circumferential direction of another second tooth tip portion or the changing portion are disposed at an interval at a same angle as a mechanical angle corresponding to an integer multiple of an electrical angle of 360° along the circumferential direction.

8. The motor according to claim 7, wherein:
at least a portion of the plurality of second tooth tip portions is formed asymmetrically in the circumferential direction when viewed from an axial direction by extending to either side of a first side and a second side in the circumferential direction from the plurality of tooth main body portions.

9. The motor according to claim 8, wherein:
a pair of second tooth tip portions that are adjacent to each other in the circumferential direction are formed asymmetrically in the circumferential direction when viewed from the axial direction, and one second tooth tip portion extends toward the other second tooth tip portion side and the other second tooth tip portion extends toward one second tooth tip portion side.

10. The motor according to claim 9, wherein:
a pair of second tooth tip portions that are adjacent to each other in the circumferential direction are formed asymmetrically in the circumferential direction when viewed from the axial direction, and one second tooth tip portion extends toward a side opposite the other second tooth tip portion and the other second tooth tip portion extends toward a side opposite one second tooth tip portion.
